(19) United States
(12) Patent Application Publication
(10) Pub. No.: US 2007/0056167 A1
(43) Pub. Date: Mar. 15, 2007

(54) Blade mounting members for a razor cartridge

(75) Inventors: Paul D. Richard, Shelton, CT (US); Thomas A. Follo, Milford, CT (US)

Correspondence Address: MICHAUD-DUFFY GROUP LLP, 306 INDUSTRIAL PARK ROAD, SUITE 206, MIDDLETOWN, CT, 06457, US

(73) Assignee: Eveready Battery Company, Inc., St. Louis, MO (US)

(21) Appl. No.: 11/521,736

(22) Filed: Sep. 14, 2006

Related U.S. Application Data
(60) Provisional application No. 60/717,526, filed on Sep. 14, 2005.

(51) Int. Cl. B26B 21/00

(52) U.S. Cl. 30/50

(57) ABSTRACT

According to the present invention, a razor cartridge a frame, at least two blades, a first group of at least two spring fingers, and a second group of at least two spring fingers. At least one spring finger (of the first group) extends toward the first end of the frame and at least one other spring finger extends towards the second end of the frame. At least one spring finger (of the second group) extends toward the second end of the frame and the cantilevered end of at least one other spring finger extends towards the first end of the frame. The first and second groups of spring fingers cooperate to dynamically mount the at least two blades in the frame such that each blade can move relative of the frame and the other blade(s) during normal shaving.

### BACKGROUND

1. Technical Field

The present invention is related to shaving implements in general, and more particularly to blade securing members for a razor cartridge.

2. Background

Prior art razor cartridges, in general, include at least one razor blade mounted in a frame. Typically, the blade(s) are mounted in the frame forward of a cap and/or aft of a guard. The razor cartridge can be mounted on a handle such that the two are not intended to be separated during normal use, or a razor cartridge can be removably mounted on a reusable handle. In the former instance, the entire razor is intended to be discarded once the blades have dulled. These shaving implements are often referred to as “disposable” razors. In the latter instance, once the blades have dulled, the razor cartridge is replaced on the same handle for continued use. These shaving implements are often referred to as “system” razors.

Various manners in which blades are mounted in razor cartridges have been developed. For example, in some prior art razors, the blades are placed in a mold, and the frame is molded around the razor blades. In these cases, the blades are held in place during the life of the razor cartridge by the molded frame material (see e.g., U.S. Pat. No. 4,586,255 to Jacobson). In other instances, the blade(s) are assembled together with the various other aspects of the razor cartridge (cap, guard, spacers, etc.) in a stack and clamped together (see e.g., U.S. Pat. No. 5,141,694 to Butlin et al.). In even further instances, the blades can be held in place dynamically using spring fingers (see e.g., U.S. Pat. No. 3,934,339 to Dawidowicz et al). In these razors, the blades are mounted on blade supports and group into a frame. Each blade is held in place by a corresponding cantilevered spring (i.e., a “spring finger”) on each end of the cartridge. The spring fingers flex when forces are placed on the blade they are supporting. The flexing of the spring fingers permits limited movement of the blade.

Those razor cartridges utilizing spring fingers have certain advantages because the blades are dynamically mounted within the razor cartridge (i.e., each blade is able to move relative to the frame as well as relative to each of the other razor blades). However, because the spring fingers of the prior art all extend from an end of the razor cartridge inward, the spring fingers are adjacent one another and tend to prevent proper rinse-through from occurring between the blades in the region near the ends of the cartridge frame.

It is, therefore, an object of the present invention to overcome the known shortcomings of the prior art.

### SUMMARY OF THE DISCLOSURE

It is one goal of the present invention to provide a razor cartridge that has dynamically mounted razor blades and improved rinse-through characteristics.

According to the present invention, a razor cartridge a frame, at least two blades, a first group of at least two spring fingers, and a second group of at least two spring fingers. The frame has a first end and a second end. The blades are positioned in the frame extending generally from the first end to the second end. The first group of spring fingers is located near the first end of the frame, and each of the spring fingers of the first group has a cantilevered end. The cantilevered end of at least one spring finger (of the first group) extends toward the first end of the frame and the cantilevered end of at least one other spring finger extends towards the second end of the frame. The second group of spring fingers is located near the second end of the frame, and each of the spring fingers has a cantilevered end. The cantilevered end of at least one spring finger (of the second group) extends toward the second end of the frame and the cantilevered end of at least one other spring finger extends towards the first end of the frame. The first and second groups of spring fingers cooperate to dynamically mount the at least two blades in the frame such that each blade can move relative of the frame and the other blade(s) during normal shaving.

According to one aspect of the present invention, the razor cartridge further includes a first intermediate support and a second intermediate support. The second intermediate support is located between the first intermediate support and the second end of the frame. The spring finger of the first group that extends towards the first end extends from the first intermediate support and the spring finger of the second group that extends towards the second end extends from the second intermediate support.

According to another aspect of the present invention, the cantilevered end of at least one spring finger is generally L-shaped. Preferably, all of the spring fingers are generally L-shaped.

According to another aspect of the present invention, both of the first and second groups of spring fingers include three, four, or more spring fingers.

One advantage of the present invention is that the spring fingers extend in different directions and, therefore, do not substantially block rinse-through at the ends of the razor cartridge between all of the blades.

### BRIEF DESCRIPTION OF THE DRAWINGS

FIG. 1 is an isometric front view of one embodiment of a shaving implement embodying the present invention;

FIG. 2 is an isometric rear view of the shaving implement shown in FIG. 1;

FIG. 3 is a rear view of one embodiment of the razor cartridge (without blades for clarity) of the present invention, wherein the first and second groups of spring fingers each include three (3) spring fingers;

FIG. 4 is a side view of a typical supported blade;

FIG. 5 is a sectional view of FIG. 3 along line 5-5, wherein the razor cartridge includes four (4) supported blades therein;

FIG. 6 is a sectional view of FIG. 3 along line 6-6, wherein the first and second groups of spring fingers both include at least one L-shaped spring fingers.

FIG. 7 is a rear view of one embodiment of the present invention, wherein the first and second groups of spring fingers each include four (4) spring fingers;

FIG. 8 is an alternative embodiment of the razor cartridge shown in FIG. 5, wherein corresponding spring fingers of the first and second groups of spring fingers (discussed infra.) extend in generally the same direction;

FIG. 9 is a sectional view of FIG. 3 along line 9-9 depicting one manner in which spring fingers can support supported blades in the razor cartridge; and

FIG. 10 is a sectional view of FIG. 3 along line 10-10 depicting one manner in which spring fingers can support supported blades in the razor cartridge.

### DETAILED DESCRIPTION OF THE INVENTION

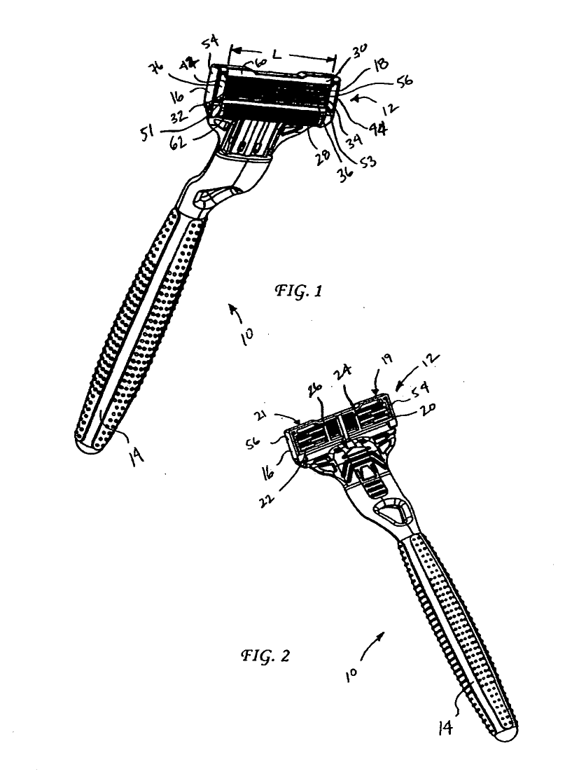

Referring to FIGS. 1-3, one embodiment of a shaving implement 10 including the razor cartridge 12 of the present invention is shown. The shaving implement 10 includes a razor cartridge 12 mounted on a handle 14. The razor cartridge 12 includes a frame 16, at least two blades 18, a first group 19 of spring fingers 20, and a second group 21 of spring fingers 22. In some embodiments, the razor cartridge 12 further includes a first intermediate support 24, a second intermediate support 26, a guard 28, and/or a cap 30. The first and second groups 19,21 of spring fingers 20,22 cooperate to dynamically mount the at least two blades 18 in the frame 16.

Shaving implements 10, also often referred to as wet shave razors, are typically sold commercially in two manners: as a “system”, or as a “disposable”. System razors typically include a permanent handle and a detachable razor cartridge. In these situations, the razor cartridge is removably attached to the handle and used until the blade(s) are dulled. Once the blade(s) are worn, the user can selectively detach the razor cartridge and replace it on the same handle with a new razor cartridge. Disposable razors include a razor cartridge permanently attached (i.e., not intended to be separated during normal use) to a handle. Once the blade(s) are worn, the user disposes of the entire device, and begins using a new disposable shaving implement. The razor cartridge 12 of the present invention can be utilized in both system and disposable shaving implements 10.

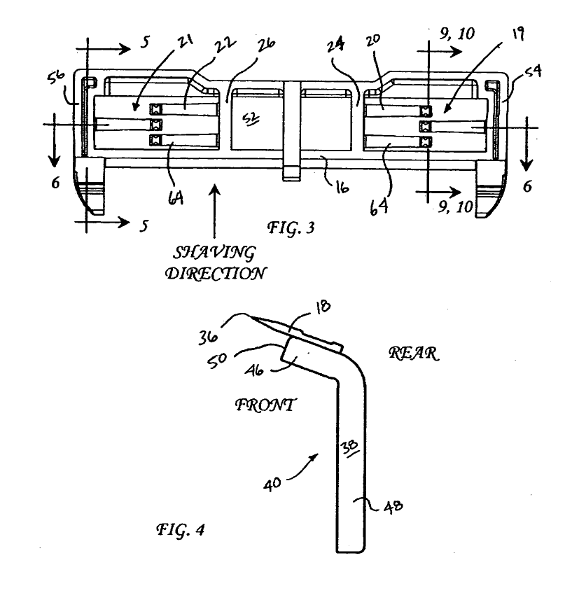

Referring to FIGS. 1 and 4, the elongated blades 18 each define a length (“L” as shown in FIG. 1), a first end 32 and a second end 34, and are disposed on the frame 16 (discussed infra) in parallel relation to one another. The razor cartridge 12 of the present invention can have two (2), three (3), four (4), or more blades 18 without departing from the scope of the present invention. Each of the blades 18 has a cutting edge 36 that extends along at least a portion of the length (L) (see FIG. 1) of the blade 18 and is, preferably, substantially planar.

Referring to FIGS. 1 and 5, the blades 18 are disposed on the frame 16 such that the cutting edge 36 of each blade 18 is located substantially near the shave plane (SP). For the purposes of the present patent application, the term “shave plane” is intended to be defined as a theoretical line extending from the outermost portion of the skin-engaging surface forward of the blades 18 (e.g., the guard 28) to the outermost portion of the skin-engaging surface aft of the blades 18 (e.g., the cap 30), as shown in FIG. 5. In other words, the cutting edge of 36 each blade 18 can be substantially contiguous with, slightly above, or slightly below the shave plane (SP).

The blade(s) 18 are mounted on a blade support structure 38, forming a supported blade 40 that has a front and a rear (as indicated in FIG. 4). The blade support structure 38 includes a first end 42 and a second end 44 (as shown in FIG. 1). Blade support structures 38 are known in the art and provide support to otherwise flexible blades 18. Blade support structures 38 are typically made of a bent piece of metal. Therefore, in some embodiments, blade support structures 38 include an angled portion 46 extending from a base portion 48 at an angle. Typically, the blade 18 is mounted on the angled portion 46 of the blade support structure 38 such that the cutting edge 36 extends past an end 50 of the angled portion 46, as shown in FIG. 4. Several methods for mounting a blade 18 to a blade support structure 38 are known in the art; however, spot welding the blade 18 onto the blade support structure 38 at various locations across the length (L) of the blade 18 has been shown to have particular utility. The supported blades each include a first end 51 and a second end 53.

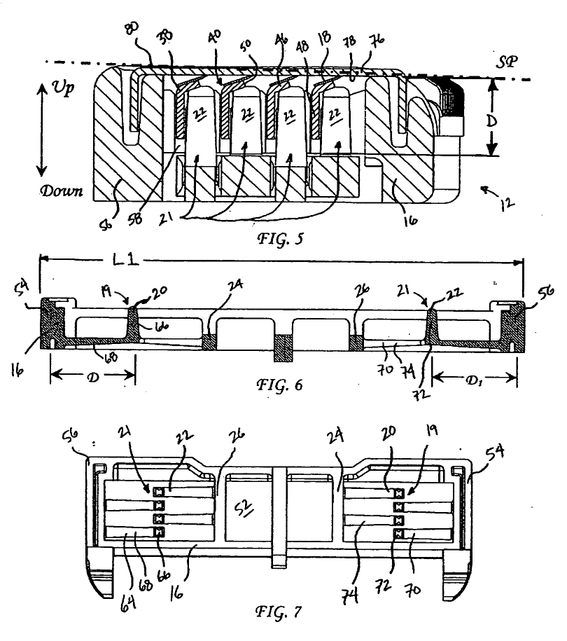

Referring now to FIGS. 1, 3, 5 and 6, the frame defines a length (L1) (see FIG. 6) and a blade area 52 into which the supported blades 40 are positioned. The frame 16 includes a first end 54, a second end 56, and, in some embodiments, can also include a guard 28 that is forward of the supported blade(s) 40 and a cap 30 that is aft of the supported blade(s) 40. The first end 54 and the second end 56 of the frame 16 include slots 58 (discussed infra) into each of which an end (first or second) 54,56 of a supported blade 40 is positioned. The frame 16 can be made from any suitable material; however, thermoplastic elastomers (also commonly known as “TPE”) have been shown to have particular utility.

In some embodiments, a cap 30 extends lengthwise across the frame 16 and includes a skin-engaging surface 60 (see e.g., FIG. 1). The skin-engaging surface 60 of the cap 30 is in contact with the surface being shaved during normal shaving operation. The cap 30 can be made of any suitable material known to those of skill in the art, and, in some embodiments, the cap 30 can include additional elements, such as the shaving aids or comfort strips. For example, the shaving aid (or comfort strip) can include one or more of the following:
A. A lubricating agent for reducing the frictional forces between the razor and the skin, e.g., a micro-encapsulated silicone oil.
B. An agent which reduces the drag between the razor parts and the shaver's face, e.g., a polyethylene oxide in the range of molecular weights between 100,000 and 6,000,000; a non-ionic polyacrylamide; and/or a natural polysaccharide derived from plant materials such as “guar gum.”
C. An agent which modifies the chemical structure of the hair to allow the razor blade to pass through the whiskers very easily, e.g., a depilatory agent is one example.
D. A cleaning agent which allows the whisker and skin debris to be washed more easily from the razor parts during shaving, e.g., a silicon polyethylene oxide block copolymer and detergent such as sodium lauryl sulphate.
E. A medicinal agent for killing bacteria, or repairing skin damage and abrasions.
F. A cosmetic agent for softening, smoothing, conditioning or improving the skin.
G. A blood coagulant for the suppression of bleeding that occurs from nicks and cuts.
H. An astringent for constricting blood vessels thereby stemming the flow of bodily fluids such as lymph, which can exude from skin which has been irritated during shaving.

Alternatively, the shaving aid can comprise one or more of the shaving aids disclosed in U.S. Pat. No. 5,056,221 to Thoene, U.S. Pat. No. 4,044,120 to Rowsell et al., U.S. Pat. No. 5,095,619 to Davis et al., which are also hereby incorporated by reference.

The guard 28, when present on the frame 16, can also be made of any suitable material known to those of skill in the art and can include additional elements, such as protrusions and/or a comfort strip (not shown) similar to the comfort strip described above in relation to the cap. The outer skin-engaging surface 62 of the guard 30 is in contact with the surface being shaved during normal shaving operation. The guard 30 is typically integrally formed with the frame 16 (see e.g., FIG. 1).

Referring to FIG. 5, the frame 16 includes slots 58 into which the supported blades 40 are positioned. Generally, the slots 58 are sized and shaped to receive an end (i.e., first or second) 51,53 of a single supported blade 40. Therefore, the frame 16 typically includes two (2) slots 58 (i.e., “corresponding slots”) per supported blade 40 in the frame 16. Corresponding slots 58 are located on the first end 54 and the second end 56 of the frame 16 and receive the first end 51 and second end 53 of the same supported blade 40, respectively. The frame 16 can include as many slots 58 as necessary, depending on the number of supported blades 40 are in the razor cartridge 12. Each slot 58 defines a depth (D) and is sized and shaped to enable the supported blades 40 positioned therein to move up and down (discussed infra), as indicated by the directional arrows in FIG. 5.

Referring to FIGS. 3, 7 and 8, the frame 16 can further include a first intermediate support 24 and a second intermediate support 26. The first intermediate support 24 is located near the first end 54 of the frame 16 and the second intermediate support 26 is located near the second end 56 of the frame, between the first intermediate support 24 and the second end 56 of the frame 16. In addition to providing additional structural integrity to the razor cartridge 12, the first and second intermediate supports 24,26 (as discussed infra) provide support for at least one spring finger 20,22 of the first and second groups 19,21, respectively. In some embodiments, the first and second intermediate supports 24,26 can be connected or even integrally formed with one another.

The first and second intermediate supports 24,26 can be of any suitable size and shape, and can be connected to any suitable portion(s) of the frame 16. As shown in, for example, FIG. 3, the first and second intermediate supports 24,26 can be substantially straight and extend across the frame in a direction parallel to the shaving direction (also indicated in FIG. 3) from the guard 28 to the cap 30. In addition, the first and second intermediate supports 24,26 can be any suitable distance away from the first and second ends 54,56 of the frame 16, respectively. Preferably, the first and second intermediate supports 24,26 are approximately 0.50 inches (1.3 cm) away from the first end and the second end 54,56 of the frame 16, respectively. However, either or both can be closer to, or further from, their respective frame 16 end 54,56 depending on the particular needs and wants of the designer. The first and second intermediate supports 24,26 can also be at least partially attached to one another (e.g., integrally formed).

Referring now to FIGS. 3 and 6-8, the frame 16 further includes a first group 19 of spring fingers 20 located near the first end 54 of the frame 16. Each spring finger 20 of the first group 19 is a cantilevered protrusion 64 that is sized and shaped to have the ability flex a desired amount. In some embodiments, at least one of the spring fingers 20 of the first group 19 is substantially L-shaped (see e.g., FIG. 6), wherein an outer portion 66 extends from a base portion 68 at an angle (e.g., 90 degrees). Even more preferably, in embodiments utilizing at least one L-shaped spring finger 20 in the first group 19, the outer portion 66 of at least one spring finger 20 is in contact with a supported blade 40.

Typically, at least one of the spring fingers 20 of the first group 19 extends from the first end 54 of the frame 16 towards the second end 56 of the frame 16, and at least one other spring finger 20 extends from the first intermediate support 24 towards the first end 54 of the frame 16. Preferably, adjacent spring fingers 20 in the first group 19 extend in opposite directions, as shown in each of FIGS. 6-8.

In some embodiments, the spring fingers 20 of the first group 19 that extend toward the second end 56 of the frame 16 and the spring fingers 20 of the first group 19 that extend toward the first end 54 of the frame 16 provide support for the supported blades 40 at approximately the same distance (D) from the first end 54 of the frame 16, as is the case in the embodiment shown in FIG. 6

Continuing to refer to FIGS. 3 and 6-8, the frame 16 further includes a second group 21 of spring fingers 22 located near the second end 56 of the frame 16. Each spring finger 22 of the second group 21 is a cantilevered protrusion 70 that is sized and shaped to have the ability flex a desired amount. In some embodiments, at least one of the spring fingers 22 is substantially L-shaped (see e.g., FIG. 6), wherein an outer portion 72 extends from a base portion 74 at an angle (e.g., 90 degrees). Even more preferably, in embodiments utilizing at least one L-shaped spring finger 22 in the second group 21, the outer portion 72 of at least one spring finger 22 is in contact with the supported blade 40.

Typically, at least one of the spring fingers 22 of the second group 21 extends from the second end 56 of the frame 16 towards the first end 54 of the frame 16, and at least one other spring finger 22 extends from the second intermediate support 26 towards the second end 56 of the frame 16. Preferably, adjacent spring fingers 22 in the second group 21 extend in opposite directions, as shown in each of FIGS. 6-8.

Similar to the first group 19 of spring fingers 20, in some embodiments, the spring fingers 22 of the second group 21 that extend toward the first end 54 of the frame 16 and the spring fingers 22 of the second group 21 that extend toward the second end 56 of the frame 16 provide support for the supported blades 40 at approximately the same distance (D₁) from the second end, as shown in FIG. 6.

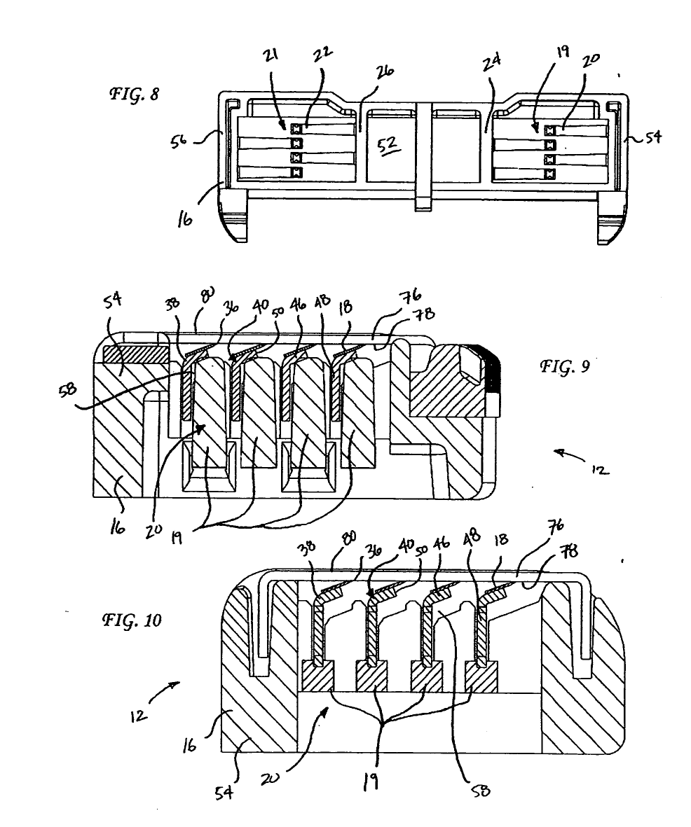

Preferably, the spring fingers 22 of the second group 21 are substantially similar in size and shape to those of the first group 19; however, any spring finger 20,22 from either the first or second groups 19,21 can be different from all other spring fingers 20,22 without departing from the scope of the present invention. In addition, the corresponding spring fingers 20,22 (i.e., spring fingers 20,22 from the first and second group 19,21 that provide support to the same supported blade40) can extend in the same (see FIG. 8) or opposite directions (see e.g., FIG. 7). In a preferred embodiment, corresponding spring fingers 20,22 all extend in either the same direction (see FIG. 8), or all extend in opposite directions (see FIGS. 3, 6 and 7).

Referring now to FIGS. 9 and 10, the spring fingers 20,22 of the first and second groups 19,21 are typically located such that they provide support underneath the supported blades 40. In other words, the spring fingers 20,22 tend to bias the supported blades 40 upwards in the slots 58. In some embodiments, such as the one shown in FIG. 9, the spring fingers 20,22 are positioned such that they contact the supported blades 40 forward of the base portion 48, and generally underneath the angled portion 46 of the blade support structure 38. In other embodiments, such as the one shown in FIG. 10, the spring fingers 20,22 are positioned such that they contact the supported blades 40 beneath the base portion 48 of the blade support structure 38. However, the present invention should not be considered to be so limited. The spring fingers 20,22 can contact the supported blades 40 at any suitable location.

Referring to FIG. 5, end caps 76 are placed over the first and second ends 54,56 of the frame 16, maintaining the supported blades 40 in their respective slots 58. The end caps 76 include an underside 78 which effectively defines an uppermost extent to which the supported blades 40 are permitted to move in the slots. In other words, the supported blades 40 are in contact with the underside 78 of the end caps 76 when the razor cartridge 12 is in an unloaded, or rest position.

It should be noted that the end caps 76 can be made of any suitable material; however, metallic materials have proven to have utility. In addition, the end caps 76 can be secured to the frame 16 in any suitable manner; however, press fitting or providing corresponding structures on the frame 16 and the end caps 76 that enable the end cap to be “snapped” into position and held in place are preferable. Typically, the topside 80 of each end cap 76 is in contact with the surface being shaved during normal use. Therefore, it is preferable that the end caps 76 have a top surface 80 that does not detract from the quality of shave provided by the razor cartridge 12.

Referring to FIGS. 1-8, in assembly, the supported blades 40 are positioned in the frame 16 such that a first end 51 of each supported blade 40 is in a slot 58 in the first end 54 of the frame 16, and a second end 53 of each supported blade 40 is in a slot 58 located in the second end 56 of the frame 16. The supported blades 40, upon placement in the slots 58, are placed into contact with corresponding spring fingers 20,22 of the first and second groups 19,21 such that each blade is supported by a spring finger 20 from the first group 19 and a spring finger 22 from the second group 21. Once the supported blades 40 are positioned in the frame 16, an end cap 76 is placed over the first and second ends 54,56 of the frame, preventing the supported blades 40 from undesirably exiting during use.

During use, the user brings the razor cartridge 12 of the present invention into contact with the surface to be shaved. As the razor cartridge 12 is moved across the surface, various forces common to shaving are exerted on the supported blades 40. As forces are applied to a supported blade 40, the corresponding spring fingers 20,22 in contact with the supported blade 40 are deflected, and the supported blade 40 moves away from the underside 78 of the end caps 76 and deeper into the slots 58 in which the supported blade 40 is positioned. Once the forces on the blades are released, the corresponding spring fingers 20,22 urge the supported blade 40 to return to the rest position (i.e., the unloaded position) and are once again in contact with the underside 78 of the end caps 76. Therefore, the supported blades 40 are able to move relative to the frame 16 and relative to one another during normal use.

Modifications and variations can be made to the above disclosure without departing from the spirit and scope of the present invention.

What is claimed is:

1. A razor cartridge, comprising:
a frame having a first end and a second end;
at least two supported blades positioned in the frame extending from the first end to the second end;
a first group of at least two spring fingers located near the first end of the frame, each of the spring fingers of the first group having a cantilevered end, wherein the cantilevered end of at least one spring finger of the first group extends toward the first end of the frame and the cantilevered end of at least one other spring finger of the first group extends towards the second end of the frame; and
a second group of at least two spring fingers located near the second end of the frame, each of the spring fingers of the second group having a cantilevered end, wherein the cantilevered end of at least one spring finger of the second group extends toward the second end of the frame and the cantilevered end of at least one other spring finger of the second group extends towards the first end of the frame;
wherein the first and second groups of spring fingers cooperate to dynamically mount the at least two blades in the frame such that each blade can move relative of the frame and the other blade(s) during normal shaving.

2. The razor cartridge of claim 1 further comprising a first intermediate support and a second intermediate support, the second intermediate support being located between the first intermediate support and the second end;
wherein the spring finger of the first group that extends towards the first end extends from the first intermediate support; and
wherein the spring finger of the second group that extends towards the second end extends from the second intermediate support.

3. The razor cartridge of claim 1 wherein the cantilevered end of at least one spring finger is generally L-shaped.

4. The razor cartridge of claim 1, wherein at least one of the blades is mounted on a blade support forming a supported blade.

5. The razor cartridge of claim 4, wherein the first end of the frame includes at least two slots and the second end of the frame includes at least two slots; and
wherein a first end of each blade is positioned one slot on the first end and a second end of each blade is positioned in one slot on the second end.

6. The razor cartridge of claim 5, wherein at least one spring finger is in contact with the blade support of one supported blade.

7. The razor cartridge of claim 1, wherein at least one pair of adjacent spring fingers of the first group extend in opposite directions.

8. The razor cartridge of claim 1, wherein at least one pair of adjacent spring fingers of the second group extend in opposite directions.

9. The razor cartridge of claim 1, wherein the first group of spring fingers includes at least three (3) spring fingers.

10. The razor cartridge of claim 1, wherein the first group of spring fingers includes at least four (4) spring fingers.

11. The razor cartridge of claim 10, wherein at least two spring fingers of the first group extend towards the first end.

12. The razor cartridge of claim 1, wherein the second group of spring fingers includes at least three (3) spring fingers.

13. The razor cartridge of claim 12, wherein the second group of spring fingers includes at least four (4) spring fingers.

14. The razor cartridge of claim 13, wherein at least two spring fingers of the second group extend towards the second end.
